(19) United States
(12) Patent Application Publication
(10) Pub. No.: US 2009/0271388 A1
(43) Pub. Date: Oct. 29, 2009

(54) ANNOTATIONS OF THIRD PARTY CONTENT

(75) Inventors: Vanessa Murdock, Barcelona (ES); Debora Donato, Barcelona (ES)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/108,444

(22) Filed: Apr. 23, 2008

(51) Int. Cl. G06F 17/30; G06F 3/048

(52) U.S. Cl. 707/5; 715/859; 707/E17.014

(57) ABSTRACT

The subject matter disclosed herein relates to creating a search query based on content and subject of a web page, for example. In one particular example, such a search query may be established by a selection of one or more keywords in a web page. Consequently, the search query may be affected by a determination of content and/or a subject of the web page.

### BACKGROUND

1. Field

The subject matter disclosed herein relates to creating a search query based, at least in part, on content of a web page.

2. Information

Web pages commonly include words or phrases that are annotated, such as with underlining or shaded text, to indicate that these words or phrases are linkable to a related web page, according to a universal resource locator (URL), for example. Annotations may be selected by an editor that reviews a web page for key words or phrases having related web pages, perhaps found by a web search. Links to related web pages may be displayed adjacent to annotated words or phrases if a user, for example, performs a mouse-over on the annotated words or phrases. The user may select any of the displayed links to jump to the linked web page from the current web page.

Instead of, or in addition to, a user selecting displayed links, the user may select annotated words or phrases to initiate a web search of the editor-selected annotated words or phrases. Web searches may yield search results that comprise long lists of search “hits”, wherein only a relatively small portion of such a list may fall within a searcher's interest.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a screenshot of a web page for explaining a particular embodiment of a web search.

FIG. 2 is a schematic diagram illustrating various entities on the World Wide Web coupled to a computing device, according to an embodiment.

FIG. 3 is a flow diagram of a process to search the Internet from a third-party web page, according to an embodiment.

FIG. 4 is a schematic diagram illustrating an exemplary embodiment of a computing environment system.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components, and/or circuits have not been described in detail so as not to obscure claimed subject matter.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining” and/or the like refer to the actions and/or processes of a computing platform, such as a computer or a similar electronic computing device, that manipulates and/or transforms data represented as physical electronic and/or magnetic quantities within the computing platform's memories, registers, and/or other information storage, transmission, and/or display devices.

Embodiments described herein relate to, among other things, creating a search query based on content or a subject of a web page, for example. In this context, content may include any object in a web page, such as ASCII characters, words, phrases, passages, photos, drawings, tables, just to name a few examples. Such content may be a basis for determining a subject of a web page. For example, by analyzing word meanings and their frequency of occurrence in a web page, a subject may be determined. Such algorithmic analysis is well-known in the art and will therefore not be discussed in further detail. As used herein, a keyword or key phrase of text may be one that relates to a subject of the text. But such a definition is not intended to be limiting.

In one particular embodiment, although claimed subject matter is not limited in this respect, a search query may be established by a selection of one or more keywords in a web page. Consequently, the search query may be affected by the outcome of a determination of content and/or a subject of the web page.

A web page may comprise a resource of information on the World Wide Web and may be accessed by a user through a web browser, for example. Such information may be coded in hypertext markup language (HTML) or extensible hypertext markup language (XHTML) format, and may enable navigation to other web pages via hypertext links, for example. The World Wide Web may be searched by forming a search query for a Web search engine, for example. In a particular embodiment, a search engine may enable a user to search for information on the World Wide Web through a browser. Such information may comprise web pages, images, and other types of files, for example. Search engines may also mine data available in newsgroups, websites grouped by subject, databases, or open directories, just to name a few examples. Unlike Web directories, which may be maintained by human editors, search engines may operate algorithmically or may be a mixture of algorithmic and human input, for example. Since search engines are well-known in the art, they will not be discussed in detail.

In another embodiment, content of a search query may be based on displayed or otherwise viewed information, or a determined subject thereof. Such displayed information may include a portion of a word processing document or a Portable Document Format (PDF) document, for example. As another example, content of a search query may be based on a user-selected portion of such a document. However, these are merely examples of viewed information, and claimed subject matter is not limited in this respect. A user-selected portion of a document need not be displayed, but may be a selected portion of addressable memory, for example.

As mentioned above, a web page may include key words or phrases that are annotated, such as with underlining or shaded text, to indicate that these words or pleases are linkable to a related web page, such as a search page, for example. Such annotations may have been selected by an editor reviewing a web page for key words or phrases having related web pages. While viewing a web page, a user may select annotated words or phrases to jump to the linked web page from the current web page.

In contrast, as in an embodiment, key words or phrases in a web page may be selected by a user, instead of an editor, as in the example above. A user may highlight words or phrases, say, with a cursor in order to initiate a web search, for example. In a particular embodiment, a user may not be limited to key words or phrases chosen a priori by an editor, but may select any words or phrases included in the web page. In particular embodiments, a user may select such words or phrases by controlling movement of a cursor with a pointing device (e.g., mouse, joystick, touch pad, and so on) to highlight the selected keywords or phrases. Such words or phrases may include words, terms, sentences, and so on. Density of words or phrases may be used to determine a subject or content of displayed information, including a web page, a document, or a portion thereof, that includes the key phrases, for example. In a particular implementation, a language processing application may use language modeling to analyze displayed information. Such a language model may assign a probability to a sequence of displayed words by means of a probability distribution, for example. However, this is merely an example, and claimed subject matter is not limited in this respect. Also, such language modeling is well-known in the art and will, therefore, not be explained further.

In one particular implementation, identifying user-selected text, such as highlighted text, may be performed by a browser, for example. Here, a browser may display a document or portion of a document in a web page comprising text. In a particular example, a user may highlight a phrase or word in such a displayed web page to begin a search query of the highlighted phrase or word. A search based merely on the highlighted text may yield a broad range of search results, only a portion of which may be of interest to the user. Accordingly, the user may be faced with a burdensome task of choosing portions of a large list of search results that he or she is interested in. There may also be a risk that search results of interest may be buried in a broad range of search results, failing to be discovered by the user. In contrast, a search query having a relatively narrow focus on the user's search interest may yield a smaller, more manageable list of search results. In an embodiment, such a search query may be based on text highlighted by the user plus additional information, such as a subject or other content associated with a web page on which the highlighted text is included. Accordingly, the subject or other web page content may enable a search query to exclude extraneous, off-subject, searches. To illustrate in one particular example, a user may highlight, or otherwise select, the word “sailing” included in a web page that describes Hawaii. If only the word “sailing” is considered in a search query, the query may return search results relating to any subject or link relevant to sailing, such as the history of sailing, sailing equipment, sailing instruction, and so on. By considering the subject or content of the web page of Hawaii in addition to the word “sailing”, however, search results may be narrowed and focused to the user's interests, namely sailing in Hawaii, for example.

In a particular embodiment, a user may create a search query by selecting and highlighting text with a cursor, for instance. As mentioned above, a user may select such text by controlling movement of a cursor with a pointing device to highlight the selected text.

In another particular embodiment, a website provider on the Internet may provide predetermined links for searching and/or locating information in specific categories of content. Such categories of content may include links to news, photos, movies, music, and finance, just to name a few examples. In an embodiment, a search based on a category of content may comprise a search that is narrowed to the particular category. For example, a music category of content may perform searches relevant to music; a news category of content may perform searches relevant to news, and so on.

A category of content may be associated with a link for performing a search that may be restricted to the category of content. For example, as mentioned above, a music category of content may be used to perform a search restricted to music. Such a restriction may allow a narrowing of a search so that search results may be focused on a topic of particular interest to a user.

In one embodiment, categories of content may be accessed via a website of a website provider on the Internet, for example. Accordingly, a user viewing such a web site may directly select a category of content most closely related to a desired search. Consequently, a new search interface may be displayed in a browser for the user to enter a specific search within the topic category. In other words, a search, initiated via a category of content, may be limited according to one or more topic categories associated with the selected category of content. Such a search according to a particular embodiment will be described in detail below.

In an embodiment, a user may select text displayed in a browser from a third-party web page on the Internet to initiate a search of that text. Also, text may include a word or phrase, for example, but claimed subject matter is not limited in this respect. Continuing with the present embodiment, a user's selected text may be used to determine content or a subject of the third-party web page. A search query may then include the selected text plus the determined content or subject of the third-party web page. Accordingly, the determined content or subject may be used to link the text search to one or more categories of content of a website provider associated with the determined content or subject. Again, this enables a more targeted search that avoids extraneous results.

In a particular example, a process for associating a search to particular categories of content on a website provider may be carried out either by the website provider, a browser associated with the user, or any entity able to process such linking, for example. In the case of a browser, for example, JavaScript may include code to enable associating a search to particular categories of content. This will be explained in more detail below. A category of content may be chosen based, at least in part, on content or a subject of a third-party web page. To illustrate by example, a third-party web page may be a home page of a business. If a user selects a word for a search, then such a search may be linked to categories of content such as news and finance, corresponding to the fact that the content or subject of the third-party web page is business. In contrast, it may be unlikely that the search would be linked to a category of content such as movies, for example.

In another particular embodiment, which will be explained in detail below, a pop-up box may appear in a browser adjacent to text selected by a user. Such a pop-up box may include a list of categories of content from which a user may choose, for example. A list of categories of content may be provided by a website provider in response to an initial search query that may be initiated by a browser hosted by the user, for example. Such an initial search query may be preliminary to a user's principle search, which may be initiated if the user chooses one or more of the categories of content in the pop-up box, for example.

A list of categories of content may include a list of one or more links that are pertinent to content or a subject of a third-party web page, for example. Such a list displayed in a pop-up box may be in order of increasing relevance to content or a subject of a currently displayed web page or document. To illustrate, using an example above, a pop-up window for a selected search word in a displayed company's web page may list increasingly pertinent categories of content, such as financial, business, technology, and so on, for example.

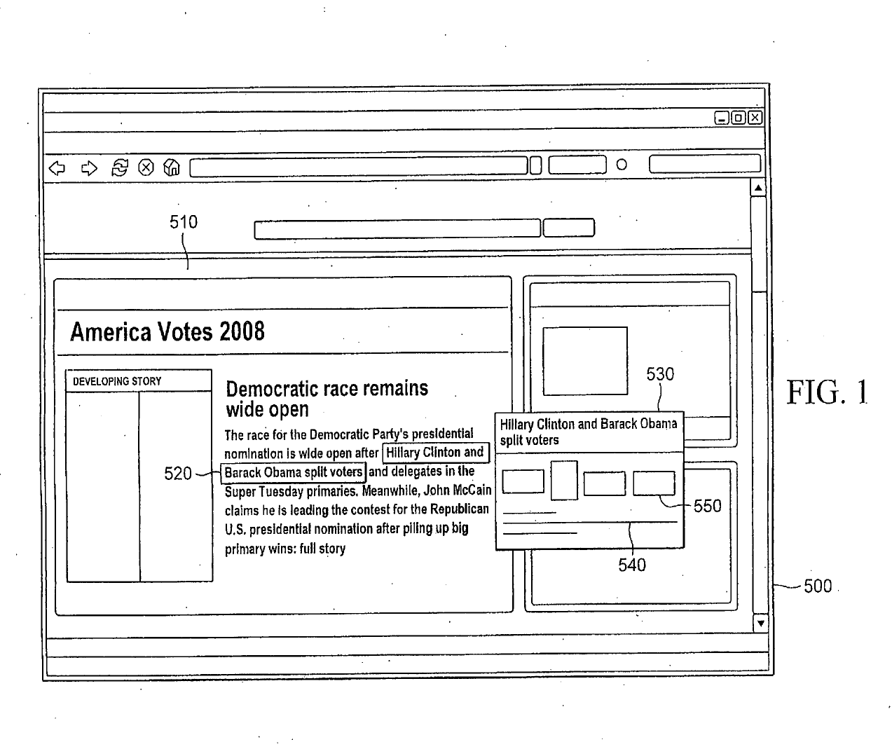

FIG. 1 is a screenshot illustrating a particular embodiment of a web search initiated from a third-party web page using category of content. A display 500 includes a third-party web page 510 hosted by a third-party website (not shown), which may be shown in a browser. Such a web page may include user-selected text 520 that is highlighted. Such highlighting of text may initiate a web search of the text, as discussed above. Consequently, one or more categories of content may appear listed in a pop-up box 530 adjacent to the selected text 520 in display 500. A user may select one or more categories of content that match closest to a topic of interest. A website provider (not shown), which provides the one or more categories of content, may perform a web search tailored to a selected one or more categories of content. The web search may be restricted to the selected one or more categories. At a conclusion of such a search, a list of search results may be returned and displayed in pop-up box 530 with the third-party web page 510. The list of search results may, for example, include links to web pages that include information corresponding to the search. Such links may be displayed in pop-up box 530 as a thumbnail photo 550 or text 540. At this time, the user may select one or more items from the list of search results. It should be understood, however, that this is merely an example according to a particular embodiment and that claimed subject matter is not limited in this respect. For example, text for a search may be selected from a word-processing document instead of a third-party web page. Also, for example, a new window may open for each selected category of content, wherein lists of respective search results may be displayed.

In order to search for desired information using a computer terminal, a browser may first be launched to connect to the World Wide Web or a local area network, for example. Here, such a browser may comprise a software application to enable communication with other devices to display and interact with text, images, videos, music, or other information that may be on a web page at a website on the World Wide Web or a local area network. Text and images on a Web page, for example, may contain hyperlinks to other Web pages at the same or different website. In a particular implementation, a browser may allow a user to access information provided on many Web pages at many websites by traversing these links, for example.

In a particular embodiment, a script comprising a portion of JavaScript code may be written on a browser. Such a script may use a browser extension such as Greasemonkey (http://diveintogreasemonkey.org/install/what-is-greasemonkey.html), for example. Such a script may enable implementation of a web search initiated from a third-party web page using a category of content process, as described in the embodiment of FIG. 1, for example. In a particular example, display 500 may include a selectable button that allows a user to enable or disable implementation of a web search using a category of content process. Such a selectable button may be included in a task bar, for example. Of course, this is just an example of how a user may enable or disable search features described herein, and claimed subject matter is not limited in this respect.

In an embodiment, a web browser may format HTML information for display on a graphical user interface. Such a browser may be used to access information provided by website providers, web servers in private networks, or content in file systems, just to list a few examples. A web browser may communicate with web servers using hypertext transfer protocol (HTTP) to access web pages. HTTP may allow a web browser to exchange information, such as web pages, with a web server. Web pages may be accessed according to a uniform resource locator (URL), for example.

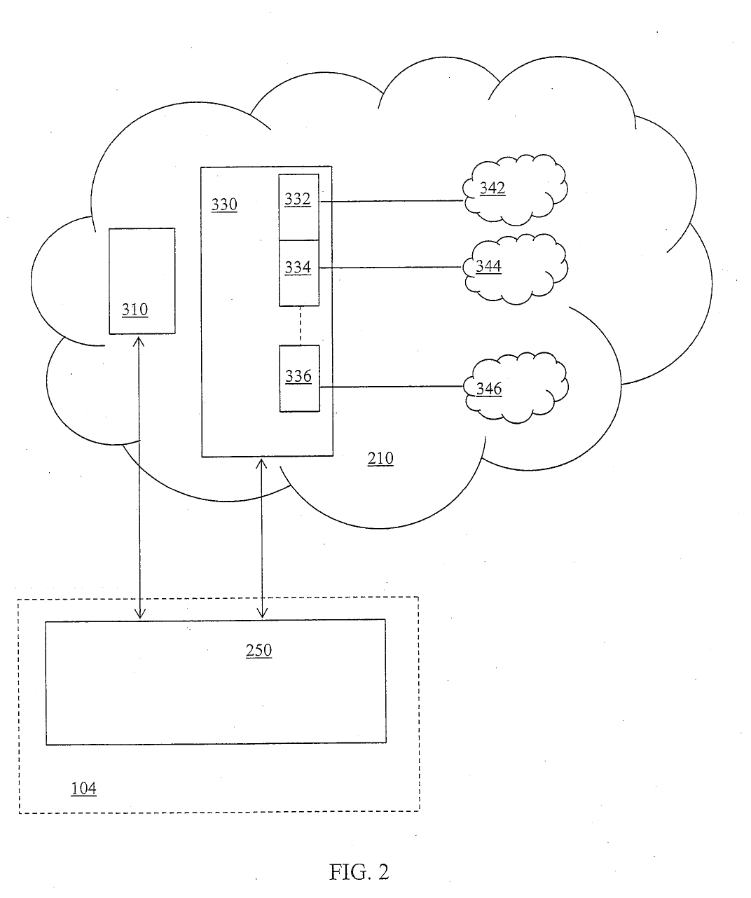

FIG. 2 is a schematic diagram illustrating an exemplary embodiment of computing device 104 coupled to, and configured to browse, Internet 210. Computing device 104 may host a web browser 250 that may be configured to communicate with various web servers on Internet 210. Such a browser configuration may include, for example, JavaScript that includes code for processing web searches as described herein. Web servers may include a third-party web page 310 and website provider 330, for example. Internet 210 may include other websites with which web browser 250 may communicate, but all such possible websites are not shown for sake of clarity.

Internet 210 may also include web pages that, for illustrative purposes, may be grouped by subject. That is, in this context, web pages may be grouped together by virtue of their respective topic, word content, image content, and so on. Accordingly, Internet 210 shown in FIG. 2 includes news webgroup 342, movie webgroup 344, and business webgroup 346, though this is merely a short list of possible groups that may be realized via the Internet 210.

In a particular embodiment, website provider 330 may provide a news category of content 332, a movie category of content 334, and a business category of content 336, though this is merely a short list of possible categories of content that may be provided by website provider 330.

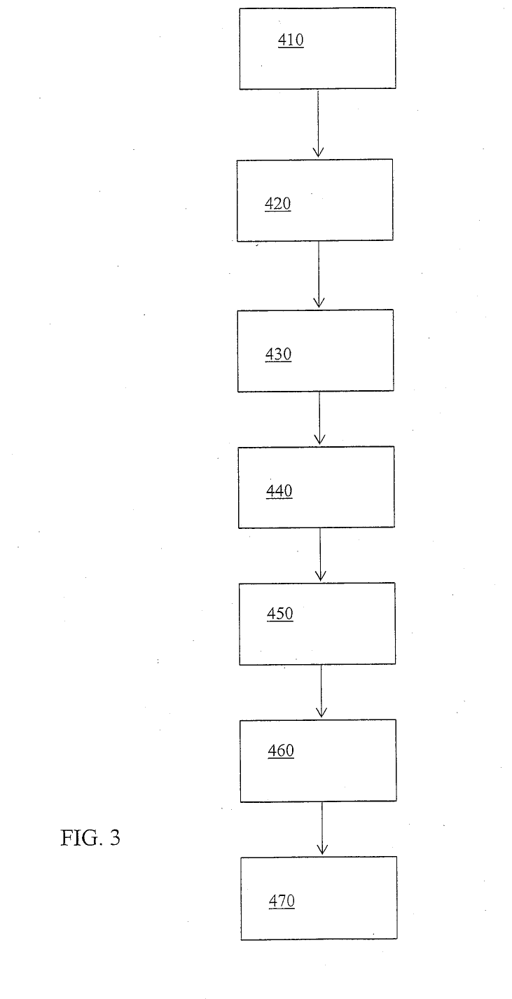

FIG. 3 is a flow diagram of a process to search the Internet based on information provided by a third-party web page, according to an embodiment. In the following example, a user is browsing third-party web page 310 using browser 250, as in block 410, though a user is not limited to such a browser. In block 420, the user selects text or an object that is a basis for a search. Such a selection may include one or more words, phrases, characters, figures, diagrams, photos, charts, tables, just to name a few examples. Methods of selecting text or an object may include, but are not limited to, highlighting the text or object, holding a mouse cursor near the text or object for an extended length of time, and a combination of key strokes, just to list a few examples. As mentioned earlier, a selection of text may invoke a script comprising a portion of, for example, JavaScript code written on a browser, though any other language may be used. Such a script, which may be user selected, may use a browser extension such as Mozilla Firefox's Greasemonkey, for example. Using such a script, for example, may enable a browser to automatically detect a selection of text on-the-fly.

In block 430, selected text or an object is submitted to website provider 330, for example. Selected text or an object may be used to formulate a URL to be communicated to website provider 330.

In block 440, website provider 330 may determine and select one or more categories of content to perform web searches for selected text or an object. Such a determination may instead be carried out by browser 250, for example. Such web searches may be focused on subject matter according to respective categories of content. Accordingly, a determination of categories of content may be based on subject or content of third-party web page 310 using a script included in a browser. In a particular embodiment, subject matter of a web page may be determined by analyzing the distribution of words, terms, or phrases in the web page that are not part of an HTML markup or scripting language, for example. Such an analysis may be performed, as in an embodiment, by constructing a histogram of the words, terms, phrases, or some portion thereof in the web page. Such histograms of one web page may then be compared to those of another web page, for example. If two or more histograms are very similar, the web pages they represent may be assumed to cover similar content.

For example, if a user browsing third-party web page 310 selects text “Star Wars”, website provider 330 or browser 250 may select movie category of content 334 after determining that the subject of third-party web page 310 is related to movies. Such a determination may be made by analyzing terms of the third-party web page 310 as described above. In contrast, news category of content 332 may not be selected unless the subject of third-party web page 310 relates to a military defense program (i.e., news-related). Consequently, movie category of content 334 may be used to launch a secondary web search in movie webgroup 344. In another embodiment, selecting text “Star Wars” may initiate a broad web search that is not limited by a subject or content of the third-party web page 310. In this case, both news category of content 332 and movie category of content 334 may be used in a web search. Search results may then be limited after they are returned and compared to a subject or content of the third-party web page 310, as explained below.

In block 450, web searches may be performed via one or more selected categories of content within their respective subject. Search results may be returned to website provider 330 or browser 250 after web searches are completed. In an embodiment, search results may be compared with a subject or content of third-party web page 310, as indicated in block 460, for example. For instance, continuing with the example above, news category of content 332 and movie category of content 334 may return web search results to be compared to a subject or content of third-party web page 310. If, in a particular example, such content includes a relatively large portion of movie words, terms, and so on, then web search results returned from news category of content 332 may be deleted, leaving web search results returned from movie category of content 334. Such a modified list of search results may subsequently be displayed, as in block 470. Search results may be listed in pop-up window 530 in display 500 (FIG. 1) within third-party web page 510 adjacent to selected text 520, for example. However, these are merely examples of displaying search results and claimed subject matter is not limited in this respect.

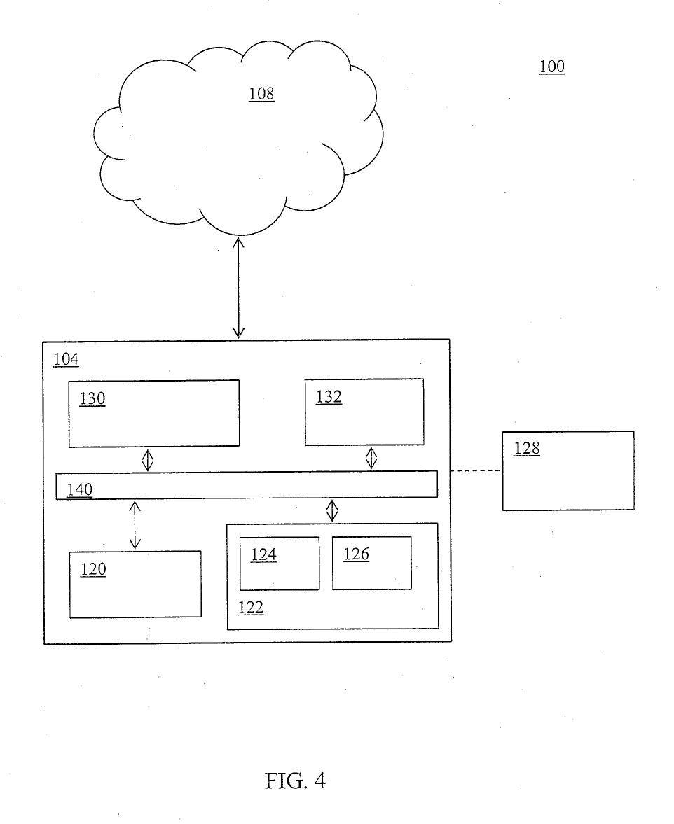

FIG. 4 is a schematic diagram illustrating an exemplary embodiment of a computing environment system 100 that may include one or more devices configurable to process internet browsing or document processing using one or more techniques illustrated herein, for example. Computing device 104, as shown in FIG. 4, may be representative of any device, appliance or machine that may be configurable to exchange data over network 108. By way of example but not limitation, computing device 104 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 108, as shown in FIG. 4, is representative of one or more communication links, processes, and/or resources configurable to support exchange of information between computing device 104 and other devices (not shown) connected to network 108. By way of example but not limitation, network 108 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It is recognized that all or part of the various devices and networks shown in system 100, and the processes and methods as further described herein, may be implemented using or otherwise include hardware, firmware, software, or any combination thereof. Thus, by way of example but not limitation, computing device 104 may include at least one processing unit 120 that is operatively coupled to a memory 122 through a bus 140. Processing unit 120 is representative of one or more circuits configurable to perform at least a portion of a data computing procedure or process. By way of example but not limitation, processing unit 120 may include one or more processors, controllers, microprocessors, microcontrollers, application specific integrated circuits, digital signal processors, programmable logic devices, field programmable gate arrays, and the like, or any combination thereof.

Memory 122 is representative of any data storage mechanism. Memory 122 may include, for example, a primary memory 124 and/or a secondary memory 126. Primary memory 124 may include, for example, a random access memory, read only memory, etc. While illustrated in this example as being separate from processing unit 120, it should be understood that all or part of primary memory 124 may be provided within or otherwise co-located/coupled with processing unit 120.

Secondary memory 126 may include, for example, the same or similar type of memory as primary memory and/or one or more data storage devices or systems, such as, for example, a disk drive, an optical disc drive, a tape drive, a solid state memory drive, etc. In certain implementations, secondary memory 126 may be operatively receptive of, or otherwise configurable to couple to, a computer-readable medium 128. Computer-readable medium 128 may include, for example, any medium that can carry and/or make accessible data, code and/or instructions for one or more of the devices in system 100.

Computing device 104 may include, for example, a communication interface 130 that provides for or otherwise supports the operative coupling of computing device 104 to at least network 108. By way of example but not limitation, communication interface 130 may include a network interface device or card, a modem, a router, a switch, a transceiver, and the like.

Computing device 104 may include, for example, an input/output 132. Input/output 132 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 132 may include an operatively configured display, speaker, keyboard, mouse, trackball, touch screen, data port, etc.

It should also be understood that, although particular embodiments have been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Such software and/or firmware may be expressed as machine-readable instructions which are executable by a processor. Likewise, although claimed subject matter is not limited in scope in this respect, one embodiment may comprise one or more articles, such as a storage medium or storage media. This storage media, such as one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
identifying user-selected text in a document displayed in a display; and
creating a search query based, at least in part, on said user-selected text and an analysis of content in said document.

2. The method of claim 1, and further comprising initiating said creating a search query automatically in response to detection of highlighting of said user-selected text.

3. The method of claim 1, and further comprising:
receiving a response to said search query; and
initiating display of linked results on said display based, at least in part, on said response.

4. The method of claim 3, wherein said linked results are displayed in said display adjacent to said cursor-highlighted text.

5. The method of claim 1, wherein said document is a web page.

6. The method of claim 1, and further comprising initiating said identifying user-selected text by cursor-highlighting said user-selected text.

7. An article comprising:
a storage medium comprising machine readable instructions stored thereon which, if executed by a computing platform, are adapted to cause said computing platform to perform the method:
identifying user-selected text in a document displayed in a display; and
creating a search query based, at least in part, on said user-selected text and an analysis of content in said document.

8. The article of claim 7, wherein said method farther comprises initiating said creating a search query automatically in response to detection of highlighting of said user-selected text.

9. The article of claim 7, wherein said method farther comprises:
receiving a response to said search query; and
initiating display of linked results on said display based, at least in part, on said response.

10. The article of claim 9, wherein said linked results are displayed in said display adjacent to said cursor-highlighted text.

11. The article of claim 7, wherein said document is a web page.

12. The article of claim 7, wherein said method further comprises initiating said identifying user-selected text by cursor-highlighting said user-selected text.

13. A method comprising:
analyzing content of a document;
identifying one or more key phrases that indicate one or more topics in said document; and
creating a search query based, at least in part, on said one or more key phrases and said one or more topics in the document.

14. The method of claim 13, farther comprising receiving linked terms in response to said search query.

15. The method of claim 14, further comprising displaying said linked terms with said document.

16. The method of claim 15, farther comprising displaying content of said linked terms if a user performs a mouse-over or highlights said linked terms.

17. The method of claim 16, wherein the displayed content of said linked terms is with a pop-up box.

18. The method of claim 13, further comprising annotating said one or more key phrases.

19. The method of claim 13, wherein analyzing content comprises determining a subject of said document.

20. The method of claim 13, wherein said search query is based, at least in part, on said subject.

21. The method of claim 13, wherein said document is a web page.
